(19) United States
(12) Patent Application Publication
(10) Pub. No.: US 2012/0023791 A1
(43) Pub. Date: Feb. 2, 2012

(54) Dynamic Indicator and Bed Employing the Same

(76) Inventor: Richard H. Heimbrock, Cincinnati, OH (US)

(21) Appl. No.: 13/192,951

(22) Filed: Jul. 28, 2011

Related U.S. Application Data
(60) Provisional application No. 61/369,482, filed on Jul. 30, 2010.

(51) Int. Cl. G03B 25/02; G09F 3/14; G09F 3/10; G09F 3/04; G09F 19/14; G09F 3/00

(52) U.S. Cl. 40/454; 40/453

(57) ABSTRACT

A bed 20 has an indicator 80 associated therewith. The indicator has a first visually perceivable state and a second visually perceivable state differing from the first state in response to a change in a direction a of observation. Collectively, the states inform an observer of a feature or capability of the bed. The indicator may be in W the form of a label 82 associable with the bed and having the first and second visually perceivable states for collectively indicating the capability or feature of the bed. In general, the indicator is associated with an article to convey information about the article.

### TECHNICAL FIELD

The subject matter described herein relates to an indicator, which may be a label, having a first visually perceivable state and a second visually perceivable state. The states differ'from each other in response to a change in a direction of observation. Taken together, the states convey information about an article. One example application for the indicator is on a hospital bed where the change in perceived state indicates a feature or capability of the bed.

### BACKGROUND

Beds of the type used in hospitals, other health care facilities and home care settings often include numerous features. These may include dynamic features that involve relative motion amongst components of the bed, or may be static features such as sockets for IV poles or oxygen tanks. Despite the utility and value of such features, caregivers may not always be intimately familiar with them or even aware of their existence, particularly if the feature or capability is uncommon, infrequently used, new to the market, nonintuitive or nonevident from a cursory inspection of the bed. It is, therefore, desirable to remind or inform caregivers of the presence of such features and capabilities and to do so in a way that is inexpensive, does not require electrical power, and that will readily capture the attention of the caregiver without being distracting or intrusive.

### SUMMARY

A bed has an indicator associated therewith. The indicator has a first visually perceivable state and a second visually perceivable state that differs from the first state in response to a change in a direction of observation. The states collectively indicate a feature or capability of the bed.

### BRIEF DESCRIPTION OF THE DRAWINGS

The foregoing and other features of the various embodiments of the indicator and bed described herein will become more apparent from the following detailed description and the accompanying drawings in which:

FIG. 1 is a perspective view of a hospital bed having a base frame, an elevatable frame and a segmented deck, the bed being shown in a horizontal configuration.

FIG. 2 is a perspective view of the bed of FIG. 1 in a chair configuration.

FIG. 3 is a view of an indicator as described herein, the indicator being in the form of a label, the illustration showing the label as perceived by an observer viewing the indicator from a first direction of observation.

FIG. 4A is a view similar to that of FIG. 3 showing the indicator as perceived by the observer viewing the indicator from a second direction of observation, the difference in perception relative to FIG. 3 indicating a dynamic feature of a hospital bed.

FIG. 4B is a view similar to that of FIG. 4A showing an alternative embodiment of the indicator.

10

FIG. 5 is a view in the direction 5-5 of FIG. 3.

FIGS. 6 and 7 are views similar to those of FIGS. 3, 4A and 4B but indicating a static feature of the bed.

FIGS. 8 and 9 are views showing a tether and a spring clip respectively for mounting an indicator as described herein on a bed frame.

FIG. 10 is a view showing an indicator as described herein mounted on a bed frame by way of a three sided indicator frame.

FIG. 11 is a top or plan view of reversible indicator.

FIG. 12 is a view taken in the direction 12-12 of FIG. 11.

FIG. 13 is a view taken in the direction 13-13 of FIG. 11.

### DETAILED DESCRIPTION

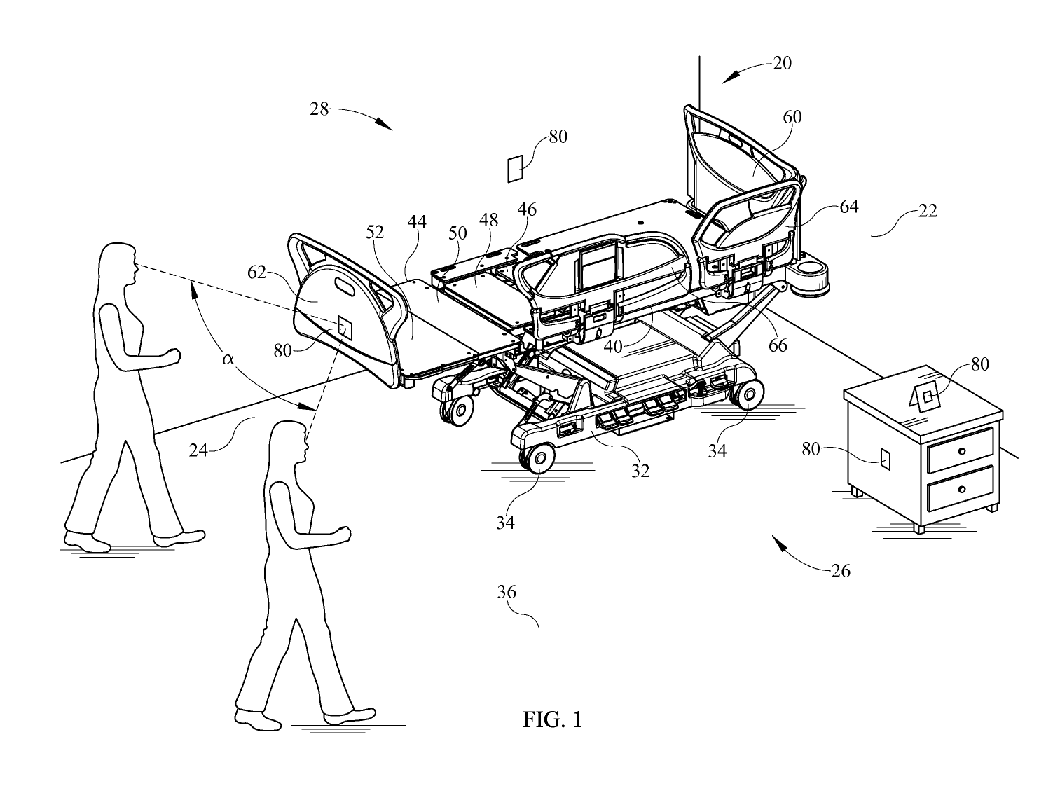

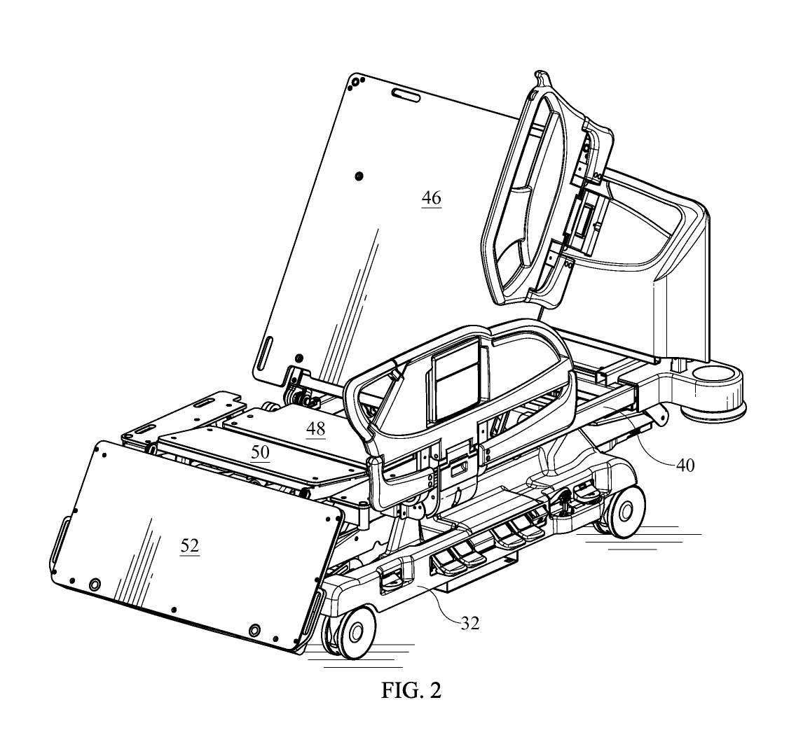

FIGS. 1 and 2 show a hospital bed 20 having a head end 22, a foot end 24 longitudinally spaced from the head end, a left side 26 and a right side 28 laterally spaced from the left side. The bed includes a bed frame assembly comprising base frame 32 with casters 34 extending to the floor 36, and an elevatable frame 40 supported on the base frame. The elevation of the elevatable frame can be adjusted relative to the base frame. The bed also includes a deck 44 supported on the elevatable frame. The illustrated deck is a segmented deck comprising a torso or upper body section 46, a seat section 48, a thigh section 50 and a calf section 52. The angular orientation of the upper body, thigh and calf sections can be adjusted to achieve a variety of desired bed profiles. A mattress, not shown, rests on the deck. The bed also includes a headboard 60 affixed to the elevatable frame and a footboard 62 affixed to the calf deck section. The bed also includes a left side head end siderail 64 a left side foot end siderail 66, a right side head end siderail, not shown, and a right side foot end siderail, also not shown. As is evident from FIG. 2 the bed can be placed in at least one chair configuration which may be suitable for facilitating occupant ingress or egress.

Referring additionally to FIGS. 3-5, an indicator 80 such as label 82 is associated with the bed by being affixed thereto, for example in a highly visible location such as the footboard 62 or one of the siderails 64, 66. Alternatively the indicator may be associated with the bed by being located in proximity thereto, for example by being mounted on a nearby wall or being placed on or mounted on a nearby article of furniture. These options, including an easle mounted option on a nearby article of furniture, are all shown in FIG. 1.

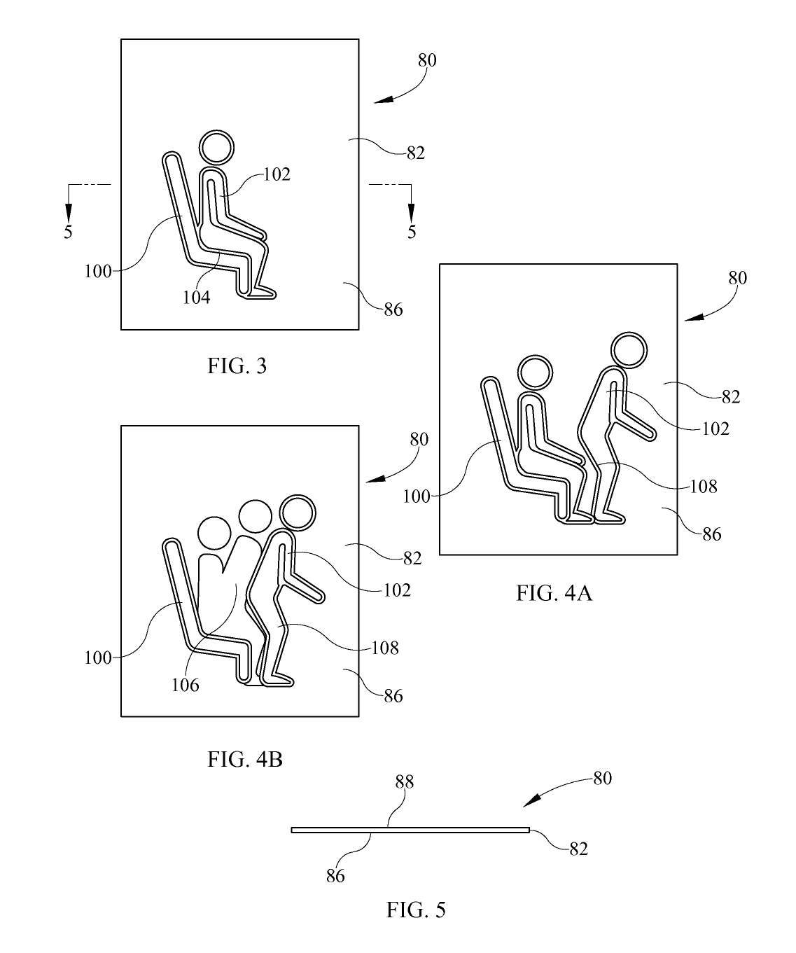

The indicator has a side 86 intended to be observed and referred to herein as the observed side, and also has a side 88 not intended to be observed and referred to herein as the nonobserved side. The observed side has a first visually perceivable state (FIG. 3) and a second visually perceivable state (FIGS. 4A, 4B) that differs from the first state in response to a change in a direction of observation, such as the directions offset from each other by angle a of FIG. 1. Collectively, the states indicate a feature of the bed. The perceivable states are pictoral images suggestive of the feature to be indicated. The images are color images but may be black and white if desired. The observed side of the label is a lenticular lens. Although the indicated feature may be chosen from a range of bed features or capabilities, the label may be especially useful if directed to a feature or capability that is uncommon, infrequently used, not intuitive or nonevident from a cursory inspection of the bed.

In the illustrated embodiments the indicated feature is a dynamic feature, i.e. one that involves relative motion amongst components of the bed. Specifically, the indicated feature is a chair egress feature, i.e. the capability of the bed to be placed in a chair-like configuration from which the occupant can exit or enter the bed. The first state (FIG. 3) is one in which the indicator displays an image 100 suggestive of the bed in a chair configuration with an occupant 102 sitting thereon in a seated posture 104, and the second state (FIGS. 4A, 4B) are states in which the indicator displays the image 100 of the bed in the chair configuration with the occupant having assumed a standing posture 108. The label may also include an optional third state (FIG. 4B) in the form of an intermediate state in which the indicator displays the image of the bed in the chair configuration with the occupant in an intermediate posture 106 intermediate the seated and standing postures 104, 108.

The states, as perceived by an observer may be mutually exclusive, at least insofar as the technology employed to render the images is capable of mutual exclusivity. In other words when viewing the indicator from a first observational direction the observer may perceive the occupant image only in the seated posture, when viewing from a second direction may perceive the occupant image only in the intermediate posture (provided an intermediate image is provided on the indicator) and when viewing from a third direction may perceive the occupant image only in the standing posture. Alternatively, the perceived image corresponding to one perceivable state may have elements in common with the perceived image corresponding to a different perceivable state. For example one state might show the occupant only in a seated posture and another state might show the occupant in both the seated and standing postures. FIGS. 3 and 4A are, in fact, examples of this alternative in that an observer's perception of the bed occupant is common to both states (FIG. 4A) or to three states (FIG. 4B), even though the depictions of the occupant are mutually exclusive. Yet another option includes ghost images. This is seen best in FIG. 4B where the dominant perceived image is that of the bed and the occupant in a standing posture, however the intermediate and seated postures are perceivable as ghost images.

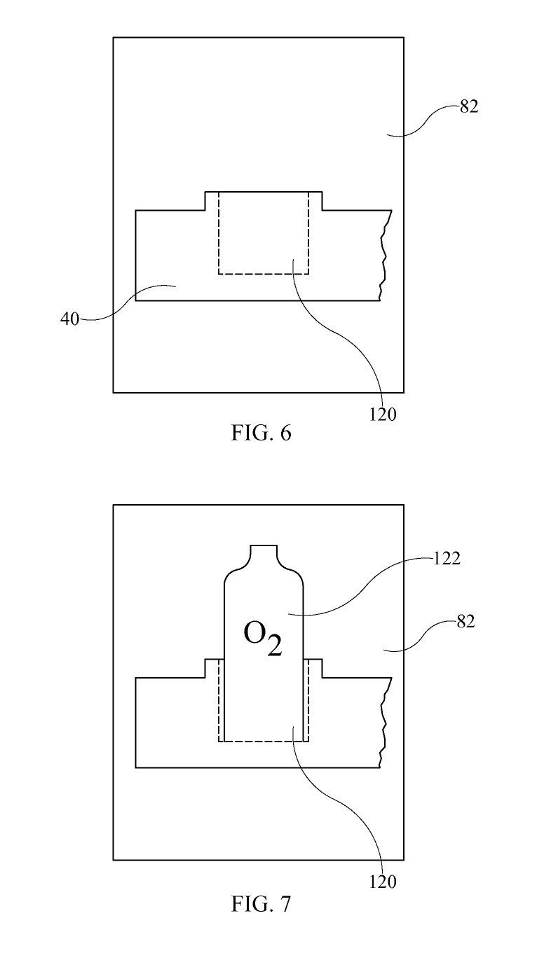

If desired, the indicated feature on the label may be a static feature rather than a dynamic feature. For example, as seen in FIGS. 6-7, the label could be used to advise an observer of the presence of a socket for an oxygen tank. In this case the first visually perceivable state (FIG. 6) shows a portion of the bed frame having an empty socket 120 and the second visually perceivable state (FIG. 7) shows the socket 120 occupied by an oxygen tank 122.

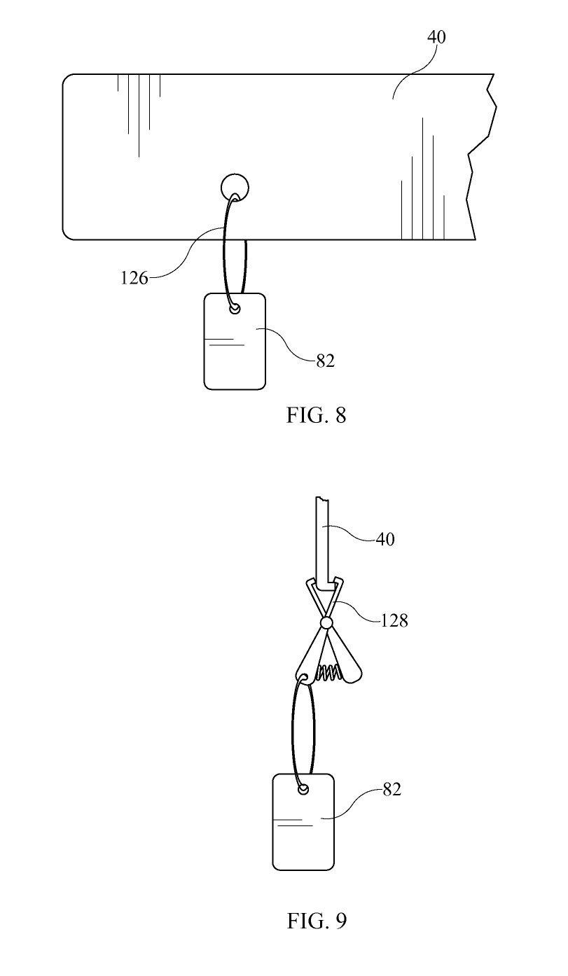

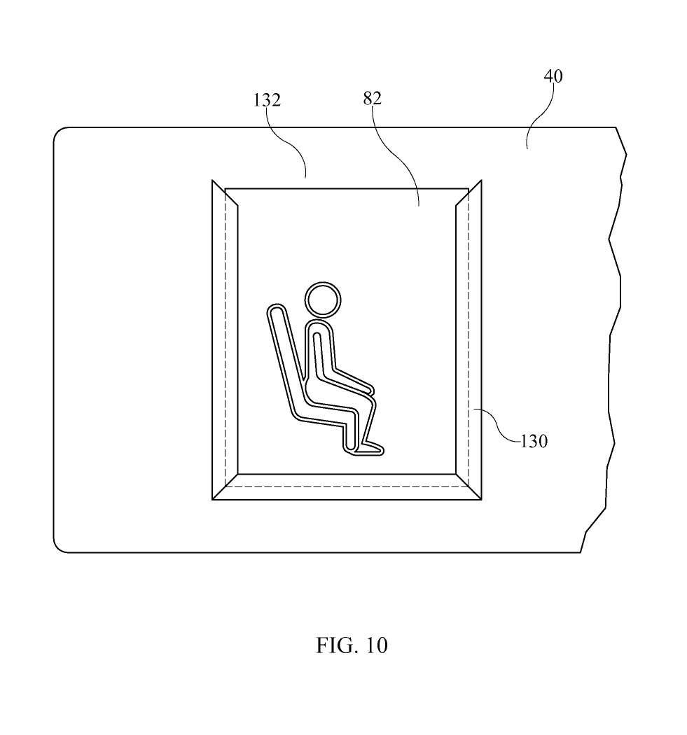

Various techniques may be used to mount the label on an appropriate host surface such as a surface of the bed, of a nearby wall, or of an article of furniture. For example the nonobserved side of the label may include an adhesive. The adhesive may be a temporary adhesive so that the label can be securely affixed to the host surface but can nevertheless be easily removed without leaving adhesive residue on the host surface. As seen in FIGS. 8-9 the label could also be mounted by way of a tether 126 or a spring clip 128. Other ways of mounting the label include taking advantage of electrostatic attraction or magnetic attraction between the host surface and the material from which the label is made. Yet another alternative, seen in FIG. 10, involves a three sided label frame 130 provided on the host surface. The label can be inserted into or removed from the frame by way of a frame loading slot or opening 132.

In some of the above examples of mounting, the affixability of the label is substantially independent of the characteristics of the host surface. For example an adhesive backing will adhere to most of the materials commonly used to manufacture bed frames, walls and furniture. Accordingly, the affixability of an adhesive backed label is, as a practical matter, substantially independent of the characteristics of the host surface. By contrast, the use of magnetic attraction requires the host surface to be magnetically responsive and therefore depends on the chaacteristics of the host surface.

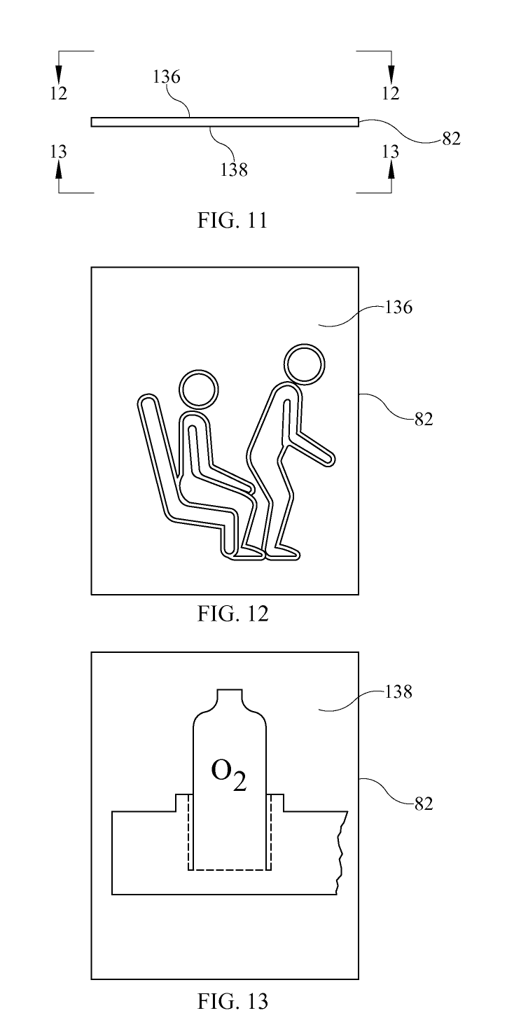

Referring to FIGS. 11-13, another embodiment of the label is a reversible label having a first observed side 136 and a second observed side 138 rather than an observed side and a nonobserved side. The first and second observed sides each have a first visually perceivable state and a second visually perceivable state that differs from the first state in response to a change in a direction of observation. Collectively, the states perceivable on side 136 indicate a first feature or capability, such as the chair egress capability, and the states perceivable on side 138 indicate a second feature or capability such as the presence of an oxygen tank socket.

In use, the indicator is affixed to a bed or to a location in proximity to the bed. As a nearby observer such as a caregiver moves relative to the bed, he or she perceives the different states of the indicator. Because the different states correspond to a change in the observer's visual surroundings, the observer's eye is easily attracted to the images on the indicator and is therefore reminded of the presence of a feature or capability.

However the indicator and changing images are not obtrusive and will not distract the observer from other matters. Moreover the indicator can be produced inexpensively.

The foregoing discussion presents the indicator in the context of a hospital bed. However the indicator can be associated with any article where there is a desire to convey information by way of two or more visually distinguishable states, one of which is perceivable from a first observational direction and the other of which is perceivable from a second, different observational direction.

Although this disclosure refers to specific embodiments, it will be understood by those skilled in the art that various changes in form and detail may be made without departing from the subject matter set forth in the accompanying claims.

I claim:

1. A bed having an indicator associated therewith, the indicator having a first visually perceivable state and a second visually perceivable state differing from the first state in response to a change in a direction of observation, the states collectively indicating a feature of the bed.

2. The bed of claim 1 wherein the indicator is associated with the bed by being located in proximity thereto.

3. The bed of claim 1 wherein the indicator is associated with the bed by virtue of being affixed thereto.

4. The bed of claim 3 wherein the indicator is mounted on the bed by a means selected from the group consisting of an adhesive, a tether, an electrostatic attraction, a magnetic attraction and a frame.

5. The bed of claim 1 wherein an observed side of the indicator is a lenticular lens.

6. The bed of claim 1 wherein the indicated feature is a dynamic feature.

7. The bed of claim 1 wherein the indicated feature is a static feature.

8. The bed of claim 1 wherein the visually perceivable states are rendered in color.

9. The bed of claim 1 wherein the perceivable states are pictoral images suggestive of the indicated feature.

10. The bed of claim 1 wherein the indicated feature is a chair egress feature.

11. The bed of claim 10 wherein the first state is one in which the indicator displays an image of the bed in a chair configuration with an occupant sitting thereon, and the second state is one in which the indicator displays the image of the bed in the chair configuration with the occupant having assumed a standing posture.

12. The bed of claim 11 including an intermediate state in which the indicator displays the image of the bed in the chair configuration with the occupant intermediate sitting on the bed and having assumed a standing posture.

13. The bed of claim 1 wherein the indicator is reversible.

14. The bed of claim 1 wherein the first and second perceivable states are visually mutually exclusive.

15. The bed of claim 1 wherein the first and second perceivable stated have a visually discernible element in common.

16. The bed of claim 1 wherein at least on of the states includes a ghost image.

17. A label for indicating a capability of a bed, the label being associable with the bed and having a first visually perceivable state and a second visually perceivable state differing from the first state in response to a change in a direction of observation, the states collectively indicating a capability of the bed.

18. The label of claim 17 wherein the label is associable with the bed by being affixable thereto.

19. The label of claim 18 wherein the affixability of the label is substantially independent of the bed.

20. The label of claim 18 whererein the affixability of the label depends on a characteristic of the bed.

21. The label of claim 17 wherein the label is associable with the bed by being affixable to a host surface in proximity to the bed.

22. An indicator associable with an article and having a first visually perceivable state and a second visually perceivable state differing from the first state in response to a change in a direction of observation, the states collectively conveying information about the article.
